(19) United States
(12) Patent Application Publication
(10) Pub. No.: US 2024/0307865 A1
(43) Pub. Date: Sep. 19, 2024

(54) PIPETTE TIP AND MOUNTING SHAFT

(71) Applicant: Integra Biosciences AG, Zizers (CH)

(72) Inventors: Terrence Kelly, Lowell, MA (US); Kyle R. DelloRusso, Derry, NH (US); Noel Pasquier, Landquart (CH); Lukas Wielatt, Chur (CH)

(73) Assignee: Integra Biosciences AG, Zizers (CH)

(21) Appl. No.: 18/601,304

(22) Filed: Mar. 11, 2024

Related U.S. Application Data
(60) Provisional application No. 63/490,891, filed on Mar. 17, 2023.

(51) Int. Cl. B01L 3/02

(52) U.S. Cl. CPC B01L 3/0237; B01L 2200/027; B01L 2200/04; B01L 2200/0689; B01L 2300/027; B01L 2400/0478

(57) ABSTRACT

A pipette tip configured to fit on a mounting shaft that includes outwardly circumferentially extending locking lobes over which the pipette tip collar is mounted. When the pipette tip is fully mounted on the mounting shaft, a locking ring on the inside surface of the tip collar engages the lobes to provide an over-center engagement. The pipette tip includes a circular cantilever sealing ring that seals laterally against the mounting shaft when the tip is fully mounted. The circular cantilever sealing ring has an annular wall surrounded by a gap. The annular wall has an inside surface that slants inward to provide a lateral interference fit with the mounting shaft. The annular wall bends radially outward towards the gap, rather than stretch, when the tip is mounted on the mounting shaft thereby reducing require insertion force.

### CROSS-REFERENCE TO RELATED APPLICATION

The present application claims priority of U.S. Provisional Patent Application No. 63/490,891, filed Mar. 17, 2023, the content of which is incorporated herein by reference in its entirety.

### FIELD OF THE INVENTION

The invention relates to improvements in handheld pipettes and automated liquid handling systems. More specifically, the invention relates to the configuration of disposable pipette tips and mounting shafts, and provides robust sealing engagement with low insertion and ejection forces while maintaining mounted pipette tips secure and stable on the respective mounting shaft during use.

### BACKGROUND OF THE INVENTION

The use of disposable pipette tips with handheld pipettors and automated liquid handling systems is well known. Disposable pipette tips enable repeated use of pipetting systems to transfer liquid reagents or liquid samples without carryover contamination. Disposable pipette tips are normally formed of a plastic material, such as polypropylene, and have a hollow, elongated, generally conical shape. The upper end of the pipette tip typically includes a collar that is mounted to a mounting shaft on the pipetting device. The mounting shaft is sometimes called the tip fitting. The mounting shaft or tip fitting includes an internal bore through which air is displaced in order to aspirate a liquid sample or reagent into the barrel of the pipette tip and then dispense the liquid sample or reagent from the pipette tip normally in another location. The distal end of the pipette tip has a small opening through which the liquid sample or reagent is received as it is aspirated into the barrel of the pipette tip and then dispensed.

Disposable pipette tips have historically relied on tapered fits between the mounting shaft and the pipette collar, as well as sealing rings on the inside circumference of the pipette collar, to secure and seal the pipette tips to the mounting shaft. With tapered fits, the seal between the mounting shaft and the disposable tip is achieved by pushing the tapered mounting shaft into the tapered collar until the mounting shaft wedges into the tip. At this point, a seal is achieved between the frustoconical tip collar and the mounting shaft as a result of crushing a sealing ring on the mounting shaft and/or stretching the diameter of the collar.

In addition to achieving a proper seal, it is also important that the position and orientation of the mounted pipette tip be stable in the face of lateral momentum or slight knocking forces that are typical during normal use such as during touch-off against the sidewall of a sample container. In order to assure tip stability, users tend to jam the mounting shaft into the collar of the tip with excessive force. In handheld pipetting, using excessive force repeatedly to mount and eject pipette tips is not desired for ergonomic reasons. Reducing insertion forces and ejection forces are particularly important in multi-channel, handheld pipettes. It is also desired to minimize insertion and ejection forces in automated liquid handling systems, which often are configured to mount and eject 96 or 384 pipettes tips contemporaneously. Reducing the insertion forces and the ejection forces can reduce the size of the motor drives used in automated liquid handling systems, reduce the system deformation, improve the tip z-position accuracy, and otherwise improve the reliability of such systems.

Various systems have been devised to provide proper sealing and stability without requiring excessive insertion and ejection forces. U.S. Pat. No. 6,955,077, entitled “Pipette Tip with an Internal Sleeve and Method for Forming Same” and U.S. Pat. No. 7,047,828, entitled “Pipette Tip with Internal Sleeve and Stabilizing Projections,” both by Blaszcak et al. are directed to a pipette tip with a bifurcated or branched sidewall portion that extends annularly upward and serves to seal the pipette tip against the mounting shaft. The branched portion forming the seal extends slightly inward from the tip wall in the relaxed position. As the conical mounting shaft is pressed into the pipette tip, the shaft engages the branched portion, pushes laterally against the branched portion and a seal forms between the pipette tip and the shaft. These patents claim to reduce necessary insertion force; however, the user can still jam the pipette tip onto the conical mounting shaft with excessive force. In other words, even though these patents describe a lateral seal, the user naturally pushes the conical mounting shaft into the tapered tip until the force is sufficient for the user to feel that the tip is secure and stable on the mounting shaft. These patents also claim to reduce potential ejection forces, however, the ejection force depends on how much force was used to mount the pipette tip in the first place.

The assignee of the present application has developed a reliable, ergonomic pipette tip mounting system described generally in U.S. Pat. No. 7,662,343 entitled “Locking Pipette Tip and Mounting Shaft,” issuing on Feb. 16, 2010; U.S. Pat. No. 7,662,344, also issuing on Feb. 12, 2010 and entitled “Locking Pipette Tip and Mounting Shaft;” U.S. Pat. No. 8,277,757 entitled “Pipette Tip Mounting Shaft” and issuing on Oct. 2, 2012; U.S. Pat. No. 8,501,118 entitled “Disposable Pipette Tip” and issuing on Aug. 6, 2013; U.S. Pat. No. 8,877,513 entitled “Method of Using a Disposable Pipette Tip” and issuing on Nov. 4, 2014; and U.S. Pat. No. 9,333,500 entitled “Locking Pipette Tip and Mounting Shaft in a Handheld Manual Pipette” and issuing on May 1, 2016, all incorporated herein by reference. In these patents owned by the assignee, the tip mounting shaft includes a locking section having circumferentially spaced outwardly extending locking lobes located above a stop which consists of a step spanning between the locking section of the mounting shaft and a lower sealing section of the mounting shaft having a smaller diameter. When the mounting shaft is fully inserted into the collar of a mating disposable pipette tip, the collar of the tip locks onto the mounting shaft. The bore of the pipette tip includes a circumferential shelf or shoulder separating its upper collar from the tip sealing area which is located below the circumferential shelf in the barrel of the tip. The tip collar preferably includes a locking ring at or near the upper opening of the collar through which the mounting shaft is inserted. The dimensions of the collar, and in particular the distance between the circumferential shoulder and the locking ring, are selected to match the dimensions of the mounting shaft between the stop and a catch surface of the upper end of the locking lobes, thus locking the pipette tip in a secure, reliable position and orientation. The locking lobes include an inclining ramp portion that generally flexes and distorts the pipette tip collar out of round as the mounting shaft is inserted into the pipette tip, rather than stretching the tip collar, thereby reducing the amount of insertion force needed to mount the tip. The preferred tip mounting shaft has three or more lobes spaced equally around the mounting shaft with recessed relief portions spanning between the lobes to accommodate inward distortion of the tip collar between the lobes. As mentioned, the lobes include an inclining ramp that gently slopes between 10-20° with respect to the vertical axis of the mounting shaft. Each lobe extends outward along the ramp towards the top of the locking section of the mounting shaft until it turns inward to form a catch surface. In some embodiments, the lobes have a declining ramp past the peak of the lobe which reduces the required ejection force compared to an abrupt catch surface. When the mounting shaft is fully inserted into the pipette tip, the locking ring on the pipette collar engages the catch surfaces or declining ramps as it is fitted over the peaks of the lobes, thereby providing a secure, snapped-on mount. The peak of each lobe is preferably slightly rounded to facilitate removal of the pipette tip.

While the collar of the pipette tip is flexed and distorted out-of-round when the mounting shaft is inserted in the pipette tip, the circumferential shoulder on the pipette tip between the collar and the barrel of the tip isolates the sealing region at the upper end of the barrel from distortion. The structural isolation provided by the circumferential shoulder in the tip facilitates reliable sealing engagement between the lower sealing section of the tip mounting shaft and the sealing region in the upper end of the tip barrel. In some embodiments, a sealing ring on the pipette tip extends inward from the upper end of the tip barrel below the circumferential shoulder and engages a sealing region on the mounting shaft below the stop with an interference fit. In some embodiments, the sealing region on the mounting shaft is frustoconically shaped. In other embodiments, the mounting shaft includes a groove below the stop that holds a sealing ring such as an elastomeric O-ring. The O-ring on the tip mounting shaft engages a sealing region at the top of the tip barrel when the mounting shaft is fully inserted into the tip. The O-ring is typically used to further reduce insertion forces with larger tips that generally have higher insertion forces than smaller tips. In each of these cases, the sealing ring or region at the upper end of the tip barrel is isolated from distortion by the structural integrity of the circumferential shoulder on the pipette tip located between the distorted locking collar and the round tip barrel.

As described in the above referenced patents owned by assignee, the combination of the locking lobes and the stop on the mounting shaft results in an ergonomic, over-center locking engagement that provides tactile feedback to the user of a handheld pipettor indicating that the disposable pipette tip is approaching and has been fully engaged on the mounting shaft. As the mounting shaft is pushed into the tip collar, the first point of contact is where the leading edge of the mounting shaft, i.e., the lower sealing section, enters through the circumferential shoulder in the pipette tip and contacts the sealing region in the tip barrel. As the mounting shaft is further depressed into the pipette tip bore, the interference for the seal increases and the inclining ramp areas of the locking lobes on the mounting shaft engage the tip collar to distort the upper portion of the collar out-of-round. While the overall insertion force is relatively light and ergonomic compared to the prior art at the time, the force increases noticeably and provides tactile feedback to the user that the tip is almost fully mounted. This level of insertion force remains somewhat steady until the stop member on the mounting shaft engages the circumferential shoulder on the pipette tip to abruptly stop further movement of the mounting shaft into the tip. At this point the lobes also snap under the locking ring on the collar, thus alerting the user not to use additional, excessive force to mount the tip. These interrelated mounting conditions result in a secure, stable mount with consistent sealing. In addition, the flexing of the collar into a distorted shape stores energy in the collar when it is mounted. To eject the tip from the mounting shaft, downward ejection force is required to release the locking ring on the collar from the locking lobes on the mounting shaft. In general, the downward ejection force causes the collar to distort further outward at the lobes so that the locking ring can slide over the peak of the respective lobes, and then release downward. When the tip is released from the lobes, the combination of the downward force from the pipette tip stripping mechanism and the stored energy in the distorted tip collar acting against the lobe geometry tend to throw the tip from the mounting shaft, thereby facilitating convenient ejection of the tips from the mounting shaft after use.

While the above tip mounting system described in assignee's previous patents provided a significant advancement in the art, in some circumstances, it may be desirable to further lessen tip insertion and ejection forces. It is a primary object of the present invention to provide a reduction in the required insertion and ejection forces without substantially affecting the stability of the mounted pipette tips.

### SUMMARY OF THE INVENTION

The invention relates to an improved seal on a pipette tip configured to mount on a tip fitting or mounting shaft having circumferentially spaced, outwardly extending locking lobes. In the above referenced patents owned by the assignee, the pipette tip seals against the mounting shaft below a circumferential shoulder of the tip between the collar and barrel of tip, i.e., the seal occurs in the upper portion of the tip barrel. In the present invention, the pipette tip has a circular cantilever sealing ring at the circumferential shoulder between the tip collar and the barrel. The circular cantilever sealing ring has a laterally resilient, annular sealing wall that extends from the circumferential shoulder on the pipette tip towards the collar opening and has an apex that abuts against the stop on the mounting shaft to provide tactile feedback that the pipette tip is fully mounted so that the user does not use excessive force in an attempt to force the pipette tip tighter onto the mounting shaft. The annular sealing wall of cantilever sealing ring slants inward slightly as it extends upward from its base. The upper portion of the annular sealing wall is displaced laterally and radially outward when the mounting shaft is inserted and forms a lateral interference seal against the mounting shaft immediately below the stop on the mounting shaft. There is an annular gap between the annular sealing wall and the tip collar. The gap enables the annular sealing wall to move laterally outward without requiring the collar to stretch, which reduces required insertion forces compared to assignee's prior art pipette tips. In addition, the sealing region on the mounting shaft is preferably cylindrical, and the inside diameter immediately below the annular sealing wall of the cantilever ring seal is preferably chosen to have zero interference with the cylindrical sealing region of the mounting shaft, to help further reduce required insertion forces.

It has been found that pipette tips incorporating the circular cantilever sealing ring require substantially less insertion force and less ejection force than prior pipette tips made by assignee. For larger tips, it may be desirable to use an O-ring in the sealing region of the mounting shaft to further reduce insertion forces, however, it is contemplated that O-rings will not be necessary even with larger tips because the configuration of the circular cantilever sealing ring reduces insertion forces significantly compared to previous sealing methods.

The presence of the circumferential shoulder of the pipette tip maintains the circular shape at the base of the circular cantilever sealing ring even when the collar is otherwise being distorted out-of-round to lock over the lobes on the mounting shaft. Similar to assignees prior pipettes, each of the locking lobes on the pipette tip mounting shaft includes an inclining ramp portion that angles outward as the inclining ramp extends upward along the mounting shaft. The purpose of the inclining ramp portion of the lobes is to facilitate distortion of the pipette tip collar out-of-round as the mounting shaft is inserted into the pipette tip. Relief portions spanning between the outwardly extending lobes and recessed with respect to the lobes accommodate inward distortion of the pipette tip collar between the lobes as in the prior art. Accordingly, when a pipette tip is mounted to a mounting shaft in accordance with the invention, the collar of the pipette tip is distorted out-of-round but the circumferential shoulder of the pipette tip between the collar and the barrel remains substantially circular and undistorted. The structural integrity of the circumferential shoulder on the tip in turn maintains the circular and undistorted shape of the base of the circular cantilever sealing ring.

Preferably, each of the locking lobes includes a peak portion that is located at a maximum outward distance from the longitudinal axis of the mounting shaft as well as a declining ramp portion that angles inward towards the longitudinal axis on the mounting shaft as it extends upward away from the peak of the lobe along the mounting shaft. However, the invention can be implemented with a mounting shaft having more abrupt catch surfaces on the locking lobes than a gently declining ramp. Also preferably, the mounting shaft has three or more locking lobes. It is preferred that the lobes comprise less than 15% of the circumference of the mounting shaft at the peak portion of the lobes with the remaining portion of the circumference of the mounting shaft being consumed by relief portions between the lobes. This configuration with relatively thin locking lobes helps to reduce friction between the tip collar and the mounting shaft and reduces insertion and ejection forces, while at the same time provides stable over-center mounting of the tip over the lobes.

The invention can be used in connection with handheld, single channel and multi-channel pipettes, as well as automated and semi-automated liquid handling equipment that use an array or matrix of multiple disposable pipette tips. The use of the described lobes and the stop on the mounting shaft also ensures that each of the pipette tips in a multi-channel application are mounted to the same height and aligned properly. As described in more detail below in reference to the drawings, the pipette tip and mounting shaft configuration of the present invention lowers required insertion an ejection forces without substantially affecting stability of the tips mounted on the mounting shaft under normal operating conditions.

These and other aspects, features and advantages of the invention are now described in greater detail with reference to the accompanying drawings.

### BRIEF DESCRIPTION OF THE DRAWINGS

FIG. 1 is a perspective view of a handheld, electronic air displacement pipette incorporating the concepts of the present invention.

FIG. 2 is a perspective view showing a disposable pipette tip and tip mounting shaft constructed in accordance with an exemplary embodiment of the present invention.

FIG. 3 is a side elevational view of the mounting shaft and pipette tip shown in FIG. 2.

FIG. 4 is a longitudinal cross-section taken along line 4-4 in FIG. 3.

FIG. 5 is a detailed view of an area encircled by line 5-5 in FIG. 4 showing an upper locking collar, a circumferential shoulder and a circular cantilever sealing ring on the disposable pipette tip illustrated in FIGS. 2 and 4.

FIG. 6 is a detailed view of the area encircled by line 6-6 in FIG. 4 showing a locking section, a cylindrical sealing section and a stop of the tip mounting shaft shown in FIGS. 2 and 4.

FIG. 7 is a side elevational view showing the mounting shaft being inserted into the disposable pipette tip.

FIG. 8 is a longitudinal cross-sectional view taken along line 8-8 in FIG. 7.

FIG. 9 is a detailed view over the area encircled by line 9-9 in FIG. 8 showing insertion of the mounting shaft into the pipette tip just prior to final engagement.

FIG. 10 is a detailed view similar to FIG. 9 showing full insertion of the mounting shaft into the pipette tip.

FIG. 11 is a view taken along line 11-11 of FIG. 10 illustrating the pipette tip collar and locking ring being distorted out-of-round when the pipette tip is fully mounted onto the mounting shaft.

FIG. 12 is a view similar to FIG. 10 illustrating the pipette tip being ejected from the mounting shaft.

FIGS. 13a-c are schematic views illustrating the interaction between an annular wall of the circular cantilever sealing ring on the pipette tip and a cylindrical sealing area on the pipette mounting shaft as the mounting shaft is inserted into the tip collar.

FIG. 14 is an enlarged cross section of the circular cantilever sealing ring and the stabilizing ring in a disposable pipette tip molded in accordance with the exemplary embodiment of the invention.

FIG. 15 contains data illustrating that using a tip mounting shaft and a disposable pipette tip constructed in accordance with the invention substantially reduces insertion and ejection forces.

FIG. 16 shows an alternative embodiment of the mounting shaft in which the sealing area on mounting shaft has O-ring.

FIG. 17 is a perspective view of an exemplary handheld multichannel pipette using the invention.

FIG. 18 is a manually assisted 96-well pipetting instrument using the invention.

FIG. 19 shows a structural analysis of a tip configured in accordance with the exemplary embodiment of the invention subject to lateral displacement at the dispensing end of the tip, as is standard pipetting practice when touching off tips.

### DETAILED DESCRIPTION OF THE INVENTION

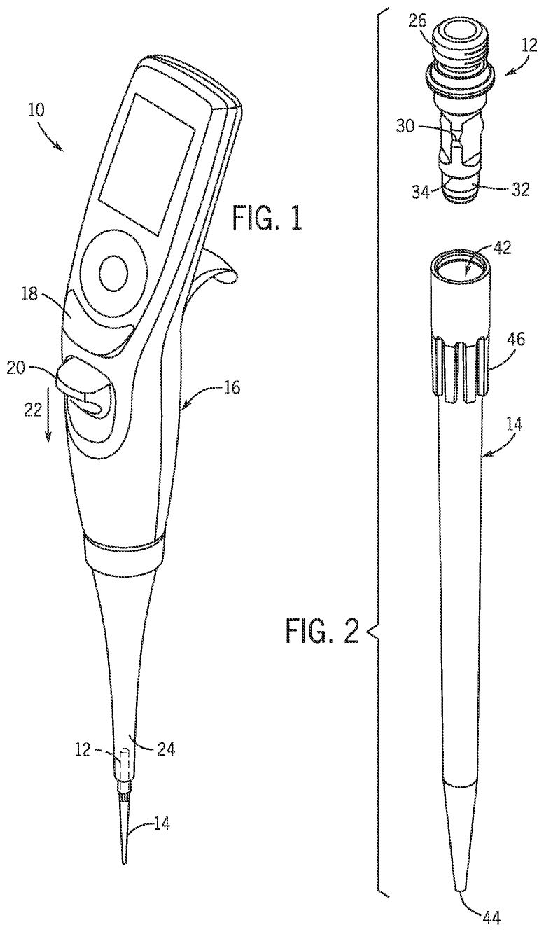

FIG. 1 illustrates a handheld, electronic air displacement pipette 10 that incorporates a tip mounting shaft 12 constructed in accordance with an exemplary embodiment of the invention. A disposable pipette tip 14 also constructed in accordance with the invention mounts to the pipette tip mounting shaft 12. Pipette tip mounting shafts 12 are also commonly referred to as tip fittings.

The handheld pipette 10 includes a housing 16 designed to be held in the palm of the user. Internal components of the pipette (not shown) drive a piston that extends through a seal assembly to displace air within an aspiration and dispensing cylinder. The tip mounting shaft 12 is threaded or otherwise attached to the lower end of the pipette 10 such that it is in fluid communication with the aspiration and dispensing chamber. The attachment of the mounting shaft 12 to the pipette is not particularly relevant to the concepts of the invention, and is well known in the art. A run button 18 is provided for the user to instruct the pipette to aspirate and dispense. The pipette 10 also includes a lever or ejection button 20 actuated in the direction of arrow 22 to move an ejection mechanism sleeve 24 downward to eject the disposable pipette tip 14 from the mounting shaft 12. The disposable pipette tip 14 is mounted for use by inserting the mounting shaft 12 on the pipette 10 into a collar of the disposable tip 14.

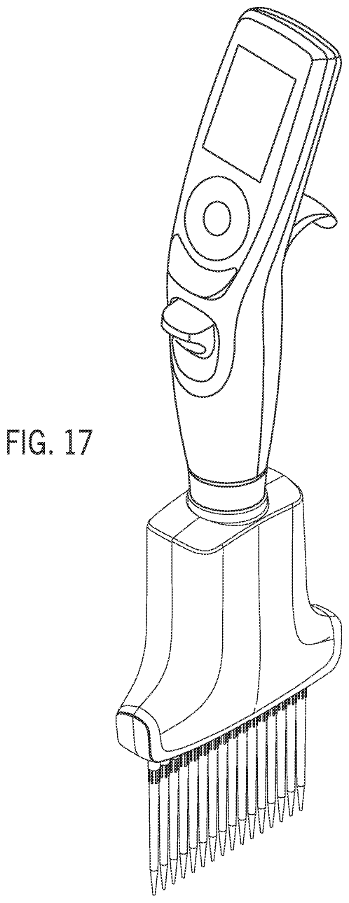

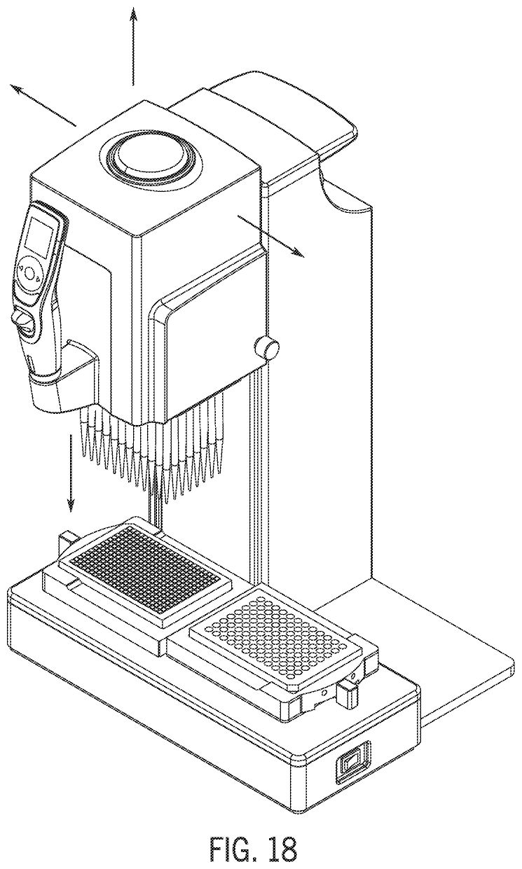

While the invention is shown and described in FIGS. 1-13 with respect to its use on a single-channel handheld, electronic air displacement pipette 10, the invention is also useful in connection with manual pipettes, electronic or manual multi-channel handheld pipettes (see FIG. 17), as well as automated liquid handling systems using disposable pipette tips and semi-automated liquid handling machines using disposable pipette tips (see FIG. 18). The invention provides robust stabile sealing engagement of each pipette tip to each mounting shaft in automated or semi-automated liquid handling systems as well as with handheld pipettes. The reduced insertion and ejection forces provided by the invention are not only useful for handheld pipettes but are also useful in automated or semi-automated systems particularly those having 96 or 384 channels.

As shown in FIG. 2, the mounting shaft 12 in this exemplary embodiment has threads 26 for attaching it to the lower end of the aspiration and dispensing cylinder (not shown) on the pipette 10. The dimensions of the mounting shaft 12 match the dimensions of the pipette tip 14 so that only pipette tips 14 with the proper dimensions fit onto the mounting shaft 12 and engage properly. For example, even if the pipette tips are constructed in accordance with the invention, if one chooses to use pipette tips with a different bore dimension in the collar or sealing region, it is necessary to replace the mounting shaft 12 and/or the tubular stripper shaft sleeve 24 with one having appropriate dimensions. On laboratory benches where multiple collar sizes of pipette tips are used, the common practice is to have multiple handheld pipettes each with different sized mounting shafts. The pipettes and the rack for storing the tips are desirably color coded so that the user can easily identify that the tips assignee's tips and have the proper collar to fit on the respective mounting shaft. In automated or semi-automated systems like that shown in FIG. 16, removable multi-channel pipetting heads have mounting shafts sized and color coded for the collar on the respective disposable pipette tips.

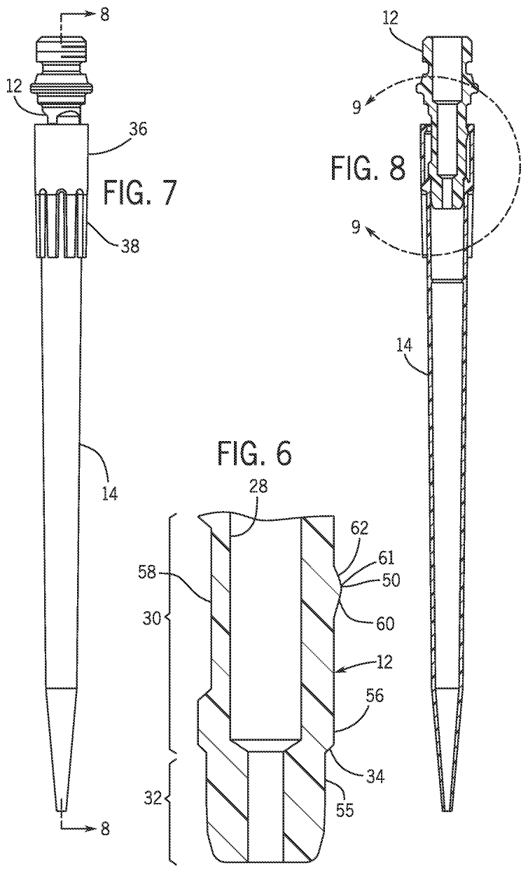

Referring now in general to FIGS. 2-6, the mounting shaft 12 contains a central bore 28 (FIG. 6) for air to pass between the aspiration and dispensing cylinder in the pipette 10 and the pipette tip 14, as is well known in the art. The pipette mounting shaft 12 includes an upper locking section 30, a lower section 32, and a stop 34 located between the upper locking section 30 and the lower section 32. Sealing occurs in the area 55 of the lower section 32 immediately below the stop 34 (see FIG. 6). The locking section 30 of the mounting shaft 12 has outwardly extending locking lobes 50 and recessed areas 58 (see e.g., FIG. 6) spanning between the locking lobes 50.

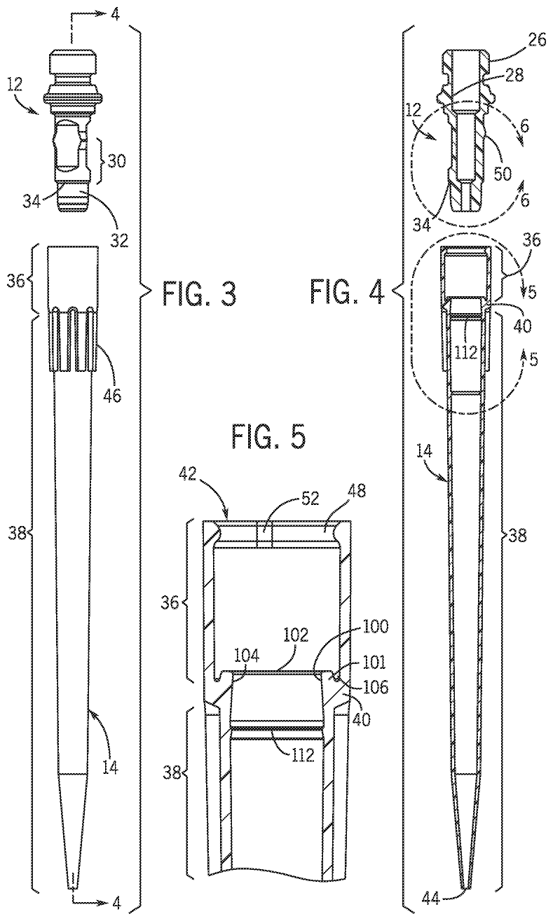

The pipette tip 14 generally consists of a collar 36, a barrel 38 and circumferential shoulder 40 (see e.g., FIGS. 4 and 5) that extends around the inside bore of the tip 14 and connects the lower end of the collar 36 to the upper end of the barrel 38. The upper end of the collar 36 has an opening 42 to receive the pipette mounting shaft 12. The lower end of the barrel 38 has a small opening 44 through which liquid is aspirated into the tip barrel 38 and dispensed from the tip barrel 38 during normal operation of the pipette 10. Support ribs 46 (FIG. 3) extend downward on the outside surface of the disposable pipette tip 14 from the collar 36. The support ribs 46 function to hold the tip 14 or an array of tips 14 in a rack for subsequent use and mounting, as is known in the art.

The preferred configuration of the pipette tip 14 is described now in reference to FIG. 5. A circumferential locking ring 48 is preferably located on inside surface of the collar 36 of the pipette tip 14. The locking ring 48 is located at or slightly below the opening 42 in the collar 36 through which the mounting shaft 12 is inserted. The locking ring 48 extends inward from the inside wall of the collar 36 a slight amount, preferably in the range of 0.025 to 0.25 mm, in order to provide an over-center locking fit over the peak 61 of the lobes 50 on the mounting shaft 12 (see FIG. 6). The locking ring 48 can contain an optional air bleed 52 although such an air bleed is not necessary in most circumstances because the distortion of the collar 36 when the tip is mounted should normally provide sufficient clearance over the recessed areas 58 of the mounting shaft 12. The inside surface of the collar 36 is preferably slightly tapered or slightly frustoconical but can also be cylindrical. The preferred taper is between 0° and 10°. In any event, horizontal cross-sections through the main section of the collar 36 are circular.

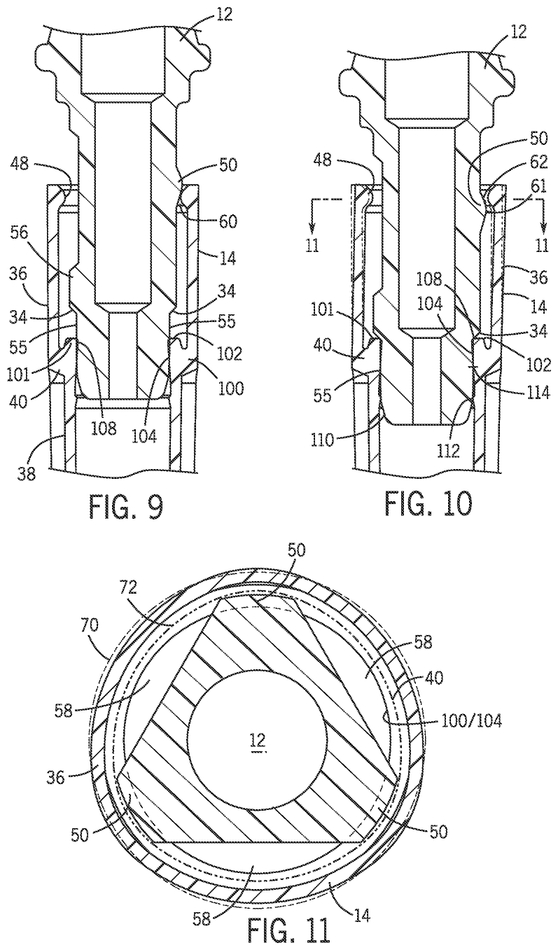

As mentioned, the circumferential shoulder 40 on the tip 14 connects the lower end of the collar 36 to the upper end of the barrel 38. A circular cantilever sealing ring 100 includes a resilient annular wall 101 that extends from the tip shoulder 40 towards the collar opening 42. The purpose of the laterally resilient annular wall 101 is to laterally engage and seal against the cylindrical sealing area 55 (see FIG. 6) on the mounting shaft 12 when the tip 14 is fully mounted to the mounting shaft 12. The annular wall 100 has an upper free end 102 that abuts the stop 34 on the pipette mounting shaft 12 when the tip 14 is fully mounted to the mounting shaft 12, see e.g., FIGS. 9 and 10.

The collar 36 of the disposable pipette tip 14 is sufficiently flexible to distort outwardly at the lobes 50 on the mounting shaft 12 and inwardly at the recessed relief portions 58 on the mounting shaft between the lobes when the pipette tip 14 is mounted on the tip mounting shaft 12. However, the circumferential shoulder 40 has sufficient structural integrity to maintain roundness of the circular cantilever sealing ring 100 so that an inside surface 104 of the annular wall 101 seals laterally against the sealing area 55 of the mounting shaft 12.

The circumferential shoulder 40 as shown in FIG. 5 is continuous around the circumference of the tip 14. The shoulder 40 in the exemplary embodiment is angular in cross section, however, it need not be angular. The circumferential shoulder 40 provides structural integrity that serves to separate and isolate the distortion of the collar 36 from circular cantilever sealing ring 100. As is best illustrated in FIG. 11, the collar 36 is distorted out-of-round when the mounting shaft 12 is fully inserted into the pipette tip 14. The circumferential shoulder 40 of the tip 14 isolates the circular cantilever sealing ring 100 from this distortion, thereby facilitating an effective lateral seal between the inside surface 104 of the annular wall 101 of the circular cantilever sealing ring 100 on pipette tip 14 and sealing region 55 (not shown in FIG. 11). the mounting shaft 12 around the entire circumference.

Referring again to FIG. 5, to accurately locate the mounting height of the tip 14 on the mounting shaft 12 when the tip 14 is fully mounted to the mounting shaft 12, the stop 34 on the mounting shaft 12 engages the top edge 102 of the annular wall 101 of the circular cantilever sealing ring 100. With multi-channel devices, this configuration ensures the same vertical mounting distance from tip to tip, which facilitates precise and consistent tip positioning during pipetting. When the tip 14 is in a relaxed state, the inside circumferential surface 104 of the annular wall 101 angles slightly inward as the annular wall 100 extends upward towards the collar opening 42. The slight inward slant provides a lateral interference fit between the inside surface 104 of the annular wall 101 and the cylindrical sealing region 55 of the mounting shaft 12 when the mounting shaft 12 is fully inserted. The annular wall 101 extends upward above the circumferential shoulder 40 such that there is a gap 106 between the annular wall 100 and the collar sidewall 36. The gap 106 enables the annular wall 100 to pivot outward laterally when the pipette mounting shaft 12 is inserted into the tip 14. The inside diameter immediately below the annular wall 101 is selected to have zero interference with the mounting shaft 14. Rather, the lateral interference fit of the annular wall 101 of the circular cantilever sealing ring 100 above the shoulder 40 of the tip 14 provides the sealing engagement of the tip 14 to the mounting shaft 12.

Referring to FIGS. 6, 9 and 10, the locking section 30 of the mounting shaft 12 has a central cylindrical aligning section 56 located immediately above and adjacent the stop 34. When the pipette tip 14 is mounted on the mounting shaft 12, the central cylindrical aligning section 56 on the mounting shaft 12 helps to maintain the tip 14 in a straight orientation, however there is preferably clearance between the collar sidewall 36 of tip 14 and central cylindrical aligning section 56 when the tip 14 is mounted on the mounting shaft 12. The diameter of the mounting shaft 12 decreases (e.g., steps down) at the stop 34 between the cylindrical section 56 above the stop 34 and the sealing section 55 below the stop 34. The reduction in shaft diameter at the stop 34 is generally commensurate with the reduction in diameter of the matching pipette tip 14 at its circumferential shelf 40. This reduction is preferably in the range of about 0.1 to 1.0 mm. It is not necessary that the cylindrical aligning section 56 and the stop 34 be continuous around the circumference of the mounting shaft 12 inasmuch as the purpose of these components is to provide secure, stable locking engagement of the pipette tip 14 on the mounting shaft 12 and not to provide a seal. In this regard, the configuration of the mounting shaft 12 in the exemplary embodiment is similar to that disclosed in the above incorporated patent applications.

Above the cylindrical aligning section 56, the diameter of the mounting shaft 12 may reduce to provide additional clearance between the mounting shaft 12 and the collar of the pipette tip 14. Referring to FIG. 6, as mentioned, the top of the locking section 30 of the mounting shaft 12 includes two or more locking lobes 50 circumferentially spaced evenly around the mounting shaft 12, as well as corresponding recessed areas 58 spanning between the locking lobes 50. The lobes 50 include relatively gently sloping inclining ramps 60. The preferred slope of the inclining ramp 60 with respect to the vertical axis of the mounting shaft is between 10° and 20°. The lobes 50 angle outward as the inclining ramp 60 extends towards a peak portion 61 of the lobe 50. Each lobe 50 also includes a declining ramp 62 which slopes inward as the declining ramp 62 extends upward away from the peak portion 61. Preferably, the inward slope of the declining ramp 62 is the same as the outward slope of the inclining ramp 60, although such symmetry is not necessary. The peak portion 61 is preferably curved and has a radius of between 0.15 and 0.38 mm. At the peak portion 61, the lobes 50 preferably extend outward beyond the outer surface of the cylindrical aligning section 56, although the exact preferred dimensions will depend on the amount of taper of the collar 36 in the corresponding matching pipette tip as well as the tip wall thickness. It is preferred that the mounting shaft 12 be made of a material to reduce rough edges and reduce friction.

Preferably, the recessed portions 58 between the lobes 50 consume a substantial portion of the circumference of the mounting shaft 12 both at the peak portion 61 and along the declining ramp 62 where the locking ring 48 on the pipette tip 14 would normally engage when the mounting shaft 12 is fully inserted into the pipette tip 14. In accordance with the exemplary embodiment of the invention, the lobes 50 at the peak portions 61 consume less than 15% of the mounting shaft circumference. The narrow locking lobes 50 reduce friction associated with mounting and ejecting pipette tips 14. Note that the recesses 58 extend downward along the mounting shaft 12 below the height of the lobes 50 to accommodate inward distortion of the tip collar 36 when the tip is mounted to the mounting shaft 12.

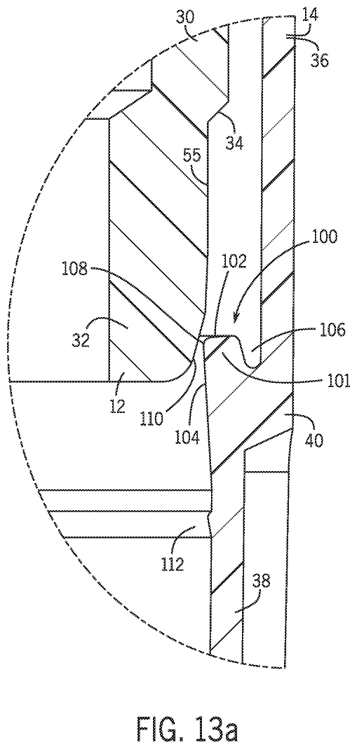

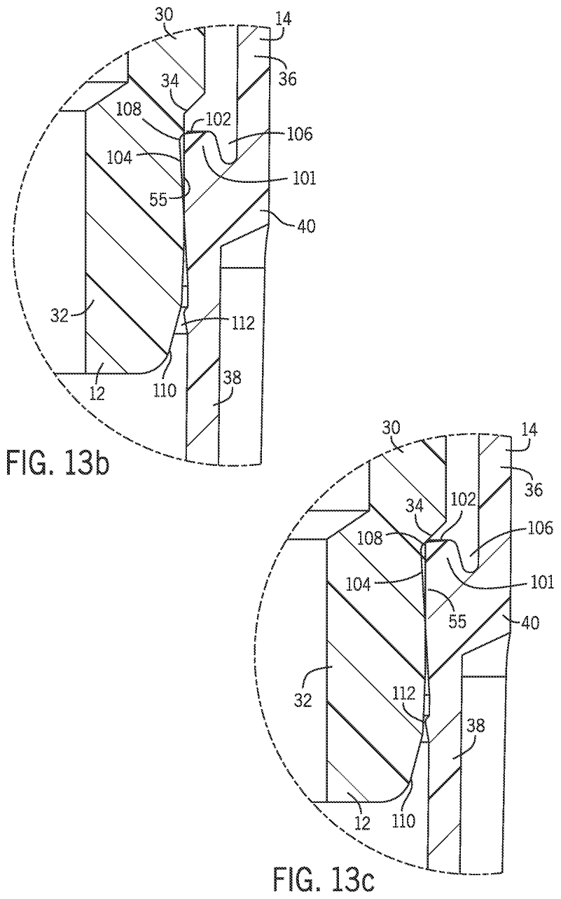

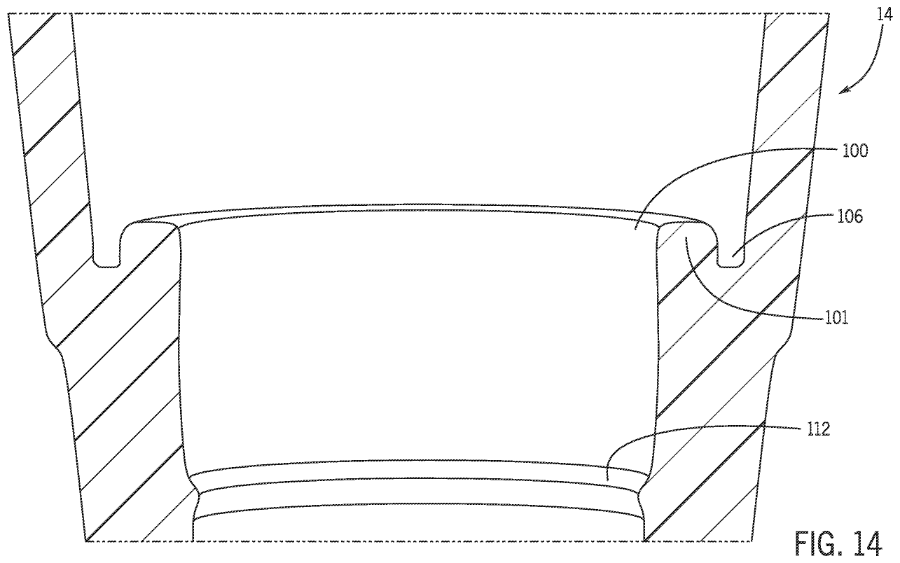

Referring now to FIGS. 13a-13c, as the mounting shaft 12 is pushed into the tip 14, the first point of contact is when the leading edge 110 of the mounting shaft 12 passes through the opening formed by the top edge 102 of the annular wall 101 of the circular cantilever sealing ring 100, FIG. 13a. The leading edge 110 of the mounting shaft 12 is tapered substantially to facilitate reliable insertion of the leading edge 110 through the upper edge 102 of the annular wall 101.

The corner between the top edge 102 and the inside surface 104 is rounded to also facilitate proper insertion. As the mounting shaft 12 continues the path of insertion, the inside surface 104 of the annular wall 100 is bent outward as the diameter of the mounting shaft 12 increases. FIG. 13b shows the lateral inside surface 104 engaging the sealing region 55 of the mounting shaft 12 to provide a lateral sealing engagement. The sealing region 55 on the mounting shaft 12 is desirably cylindrical such that the lateral seal is cylindrical and vertical. This configuration, with the cylindrical sealing region 55 on the mounting shaft 12, is particularly advantageous since the lateral cylindrical seal provides robust sealing and does so with relative low insertion force. In FIG. 13b, the annular wall 101 and its inside surface 104 have been drawn as though the annular wall 104 theoretically did not bend outward as the mounting shaft 12 is inserted. FIG. 13b as drawn illustrates the amount of interference between the inside surface 104 of the annular wall 101 and the cylindrical sealing region 55 on the mounting shaft 12. FIG. 13c is drawn in a similar fashion.

FIG. 13c shows the mounting shaft 12 fully inserted into pipette tip 14 with the circumferential stop 34 on the mounting shaft 12 contacting the top edge 102 the annular wall 101 of the circular cantilever sealing ring 100 on the tip 14. As mentioned, the stop 34 in the exemplary embodiment is angled such that it contacts the corner 108 between the inside surface 104 and the top edge 102 of the annular wall 101. The stop 34 is not intended to seal at this location and can optionally include one or more voids around its circumference to ensure that sealing does not take place against the stop 34. Having the stop 34 at an angle is advantageous because it accommodates manufacturing tolerances in the mounting shaft 12 or the pipette tip 14.

Reference number 114 in FIG. 13c identifies the threshold location of zero interference between the inside surface 104 of the annular wall 101 of the circular cantilever sealing ring 100 on the pipette tip 14 and the cylindrical sealing region 55 of the mounting shaft 12. The lateral interference seal occurs on the inside surface 104 above the threshold location 114 of zero interference and the corner 108. The vertical length of the interference is desirably 0.20 to 0.30 mm in this exemplary embodiment. The maximum interference is desirably 0.08 mm, which has been found to provide robust sealing even when normal machining and molding tolerances are taken into account. The annular wall 101 bends radially outward into the gap 106 to accommodate the interference between the cylindrical sealing region 55 on the mounting shaft 14 and the inside surface 104 of the annular wall 104. The height of the gap 106 in this exemplary embodiment is 0.30 mm, and its max width is 0.30 mm.

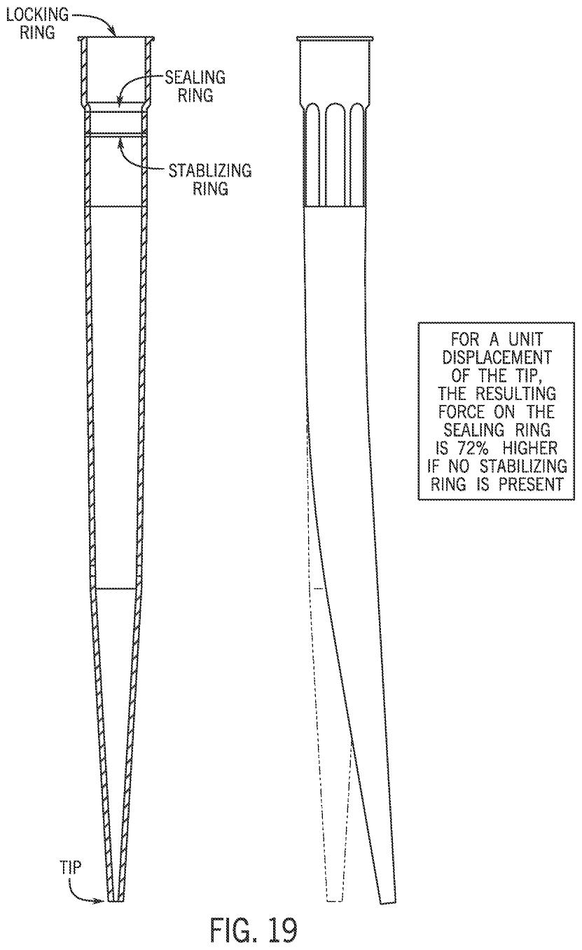

The diameter of mounting shaft 12 tapers slightly between the cylindrical sealing region 55 and the more aggressively tapered leading edge 110. At the same time, the diameter of the inside surface of the pipette tip 14 below the threshold location 114 of zero interference continues to expand slightly in order to ensure that there is clearance and very little friction below the threshold location 114. Still referring to FIG. 13c, just above the aggressively tapered leading edge 110, the mounting shaft 14 abuts a stabilizing ring 112 in the upper end of the barrel 38 of the pipette tip 14. The stabilizing ring 112 aligns the tip 14 on the mounting shaft 12 such that the circular cantilever sealing ring 100 does not need to align the tip 14, thereby improving both the symmetry of the interference fit at the lateral seal 104 and alignment of the tip opening 44 (FIG. 2). The structural modeling of a tip (FIG. 19) showed that the removal of the stabilizing ring 112 raises the force on the sealing ring 100 by 72%, increasing the risk of liquid leaking (for example, during touch-off). This was empirically confirmed in experiments demonstrating that tips without a stabilizing ring 112 consistently leaked when a lateral displacement was applied versus tips with a stabilizing ring given that equivalent lateral displacement which did not leak.

Referring now to FIGS. 9 and 10, as the mounting shaft 12 is inserted into the tip 14, the inclining ramp 60 of the locking lobes 50 begin to engage the upper portion of the tip collar 36 just prior to the time that the circumferential stop 34 on the mounting shaft 12 contacts top edge 102 of the annular wall 101 of the circular cantilever sealing ring 100 on the tip 14. As the mounting shaft 12 is further inserted into the tip, the inclining ramp 60 on the lobes 50 push against the locking ring 48 on the tip collar 36 to gently flex the collar 36 and distort it out-of-round. The recessed areas 58 on the mounting shaft 12 provide ample clearance for the straightening of the collar 36 that occurs between the lobes 50. The intent is for the lobes 50 on the mounting shaft 12 to flex the collar out-of-round rather than to stretch the collar 36 on the mounting shaft 12. When the mounting shaft 12 is fully inserted into the pipette tip collar 36, see FIG. 10, the stop 34 on the mounting shaft 12 abuts the corner 108 of the annular wall 100 of the circular cantilever sealing ring 100 on the pipette tip 14, thus preventing further movement of the shaft 12 into the tip 14. At the point of engagement, the locking ring 48 on the inside surface of the tip collar 36 more or less simultaneously slides over the peak portion 61 of the lobes 50 on the mounting shaft 12 such that the locking ring 48 engages the declining ramp portion 62 of the lobe 50. Thus, the pipette tip 14 is securely locked into place on the mounting shaft 12 with there being a positive engagement between the stop 34 on the mounting shaft 12 and the corner 108 of the annular wall 104 on the pipette tip 14 on one hand; and, the declining ramp portion 62 of the lobes 50 on the mounting shaft 12 and the underside of the locking ring 48 on the tip collar 36 on the other hand. As mentioned previously, the stabilizing ring 112 in the top of tip barrel 38 aligns the tip 14 below the circular cantilever sealing ring 100, whereas the interaction between the lobes 50 on the mounting shaft 12 and the locking ring 48 on the tip collar 36 provide alignment above the circular cantilever sealing ring 100.

FIG. 11 shows a cross-sectional view looking down on the tip collar 36 being locked onto the mounting shaft 12 over the lobes 50. The collar 36 is flexed and distorted to an out-of-round condition. Note that phantom line 70 indicates the outside surface of the collar opening in its relaxed round state before being mounted on the mounting shaft 12. The phantom line 72 indicates the position of the inside surface of the locking ring 48 on the collar 36 in its relaxed round state before being mounted over the lobes 50 on the mounting shaft 12. While the mounted collar 36 is flexed and distorted out-of-round, the circumferential shoulder 40 and the circular cantilever sealing ring 100 remain circular due to the structural integrity circumferential shoulder 40.

By flexing and distorting the tip collar 36 rather than stretching the collar 36 in order to mount the tip 14, the required insertion force is less compared to tip mounting configurations that require tight interference fits or stretching of the tip collar. In addition, as mentioned above, the bending of the annular wall 101 of the circular cantilever sealing ring 100 when providing the lateral interference seal, further reduces required insertion forces compared to stretching the tip or crushing an annular seal on the pipette tip. Still, the user receives definite tactile feedback that full engagement has occurred when the stop 34 engages the circular cantilever sealing ring 100 on the tip 14, the locking ring 48 on the tip 14 slides over the lobes 50 and the mounting shaft 12 abuts the stabilizing ring 112. The locking engagement is robust and prevents unintentional de-mounting of the tip when a side force is applied to the tip, such as during a touching off procedure. And, the seal is robust even though low insertion force is required.

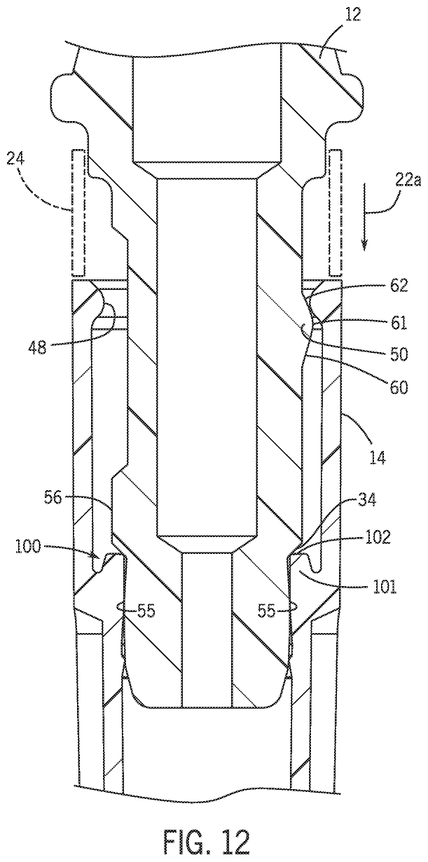

Another advantage of the invention is lower ejection forces, which is not only advantageous for handheld single channel and multi-channel pipettes but also advantageous for automated or semi-automated systems. Referring to FIG. 12, a stripping sleeve 24 is shown moving downward (arrow 22a) to push on the top of the collar 36 to eject the tip 14, as is common in the art. Once the locking ring 48 clears the peak portion 61 on the lobes 50, energy stored in the distorted collar 36 is released and facilitates efficient ejection of the tip 14 from the mounting shaft 12. The use of lobes 50 with a gently sloped declining ramp 62 and a curved peak portion 61 connecting an inclining ramp 60 to the declining ramp 62 reduces the required ejection force yet provides ample lateral stability. Further, since the configuration (i.e., use of a stop 34) prevents over insertion of the mounting shaft 12 into the tip 14, the required ejection force is consistent and not dependent on how deep the mounting shaft 12 was inserted as in some prior art pipette tips. Additionally, releasing the tip 14 from the circular cantilever sealing ring 100 takes less force than from prior art annular sealing rings that rely on stretching the tip or crushing the sealing ring.

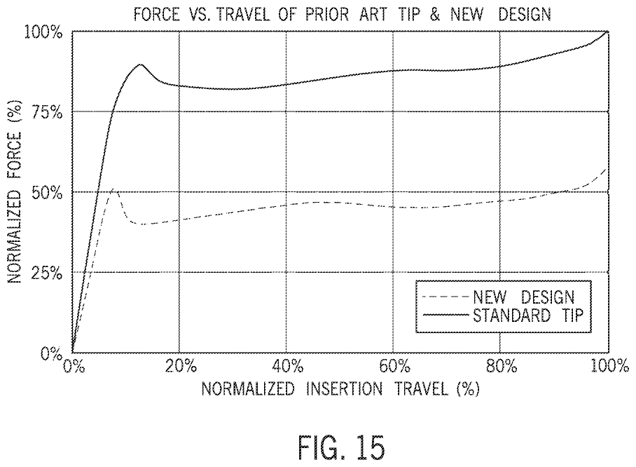

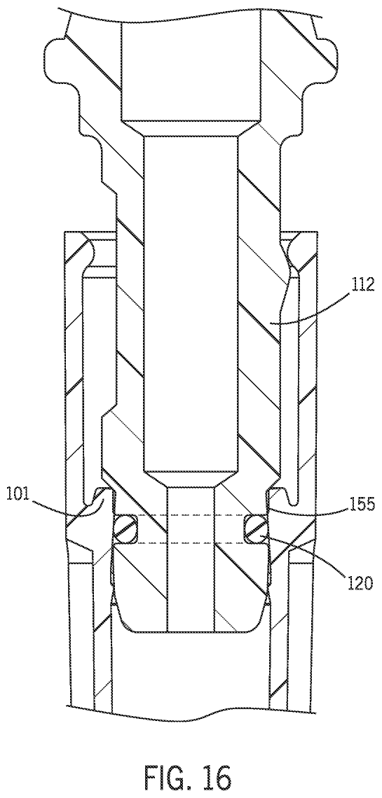

The disposable pipette tips 14 are typically made by injection molding virgin polypropylene. FIG. 14 is an enlarged cross section of a portion of a polypropylene pipette tip 14 molded to have a configuration in accordance with the exemplary embodiment of the invention, described in FIGS. 1-13. FIG. 14 shows the cross section of the circular cantilever sealing ring 100 and the stabilizing ring 112. The pipette tip is for a 125 μl fitting. The minimum diameter of the inside surface 104 of the annular wall 101 of the circular cantilever sealing ring 100 is 2.58 mm+/−a molding tolerance. The height of the gap 106 around the annular wall 101 is 0.30 mm+/−a molding tolerance. The inside diameter of the stabilizing ring 112 is 2.58 mm+/−a molding tolerance. FIG. 15 contains data that compares insertion forces for tips illustrated in the photograph of FIG. 14 and constructed in accordance with the invention to insertion forces for tips constructed according to assignee's previous design in which sealing occurred using a sealing ring in the barrel of the tip. The data in FIG. 15 shows that the maximum force needed to insert the mounting shaft 12 into a pipette tip 14 constructed in accordance with the invention is substantially less than the maximum force needed to insert the mounting shaft 12 into a pipette tip 14 that is similarly sized (125 μl) and constructed in accordance with assignee's previous design. The y-axis in FIG. 15 plots insertion force as a percentage of the maximum insertion force of the previous design, and the x-axis plots insertion distance as a percentage of the end of the insertion process. In both cases, the required insertion force has a local peak as the locking ring 48 on the pipette tip 14 is distorted when the inclining ramps 60 on the lobes 50 of mounting shaft 12 are being pushed against the locking ring 48. The local maximum for assignee's former design is about 89%, whereas the local maximum for tips constructed in accordance with the invention is about 50%. As the mounting shaft 12 is further inserted, the insertion force drops slightly as the peak of the lobes 50 clear the locking ring 48 on the tip collar. Then, the insertion force in both cases trends upward slightly until the stop 34 on the mounting shaft 12 reaches its end of travel. The assignee's previous tips require approximately 100% at the end of the insertion process, whereas tips constructed in accordance with the invention require about 58% at the end of the insertion process. The reduction in the insertion forces is attributable to the use of the circular cantilever sealing ring 100 instead of a sealing ring in the barrel that requires the barrel to stretch or that the sealing ring be crushed.

The data in FIG. 15 is for a 125 μl pipette tip, but the invention is useful for pipette tips having collars with different sizes. For tips having larger tip collars, it may be desirable to modify the design as illustrated in FIG. 16 to incorporate an O-ring 120 in the sealing region 155 of the mounting shaft 112. The configuration of the circular cantilevered sealing ring 100 is conceptually unchanged, however, the O-ring 120 engages the inside surface of the annular wall 101 instead of a cylindrical portion of the mounting shaft 112. Despite the ability to operate effectively with a mounting shaft 112 having an O-ring 120, the invention reduces the insertion forces significantly and it is contemplated that the invention will eliminate the need to use O-rings 120 in most practical circumstances.

While the above embodiments of the invention have been described in connection with a single channel handheld pipette, the invention is also quite useful for multi-channel handheld pipettes, an example of which is shown in FIG. 17. The invention is also useful for automated liquid handling systems and semi-automated liquid handling systems. FIG. 18 shows an exemplary a manually directed, 96-channel semi-automated pipetting system that can be set up to use pipette tips configured in accordance with the invention.

It should be understood by those skilled in the art that while exemplary embodiments of the invention have been described in connection with the drawings, various aspects and features of the invention can be implemented in other forms. For example, it may not be necessary that the mounting shaft have more than two lobes even though it is described as having three lobes.

What is claimed is:

1. A disposable pipette tip for use with a pipetting system having a tip mounting shaft that includes an upper locking section having a stop, multiple outwardly extending lobes located above the stop and spaced circumferentially around the locking section of the mounting shaft, and recessed relief portions spanning circumferentially between the lobes and recessed relative to the lobes, each respective lobe having a peak being spaced longitudinally above the stop on the mounting shaft by a predetermined distance, and said tip mounting shaft also including a sealing area located below the stop, said disposable pipette tip comprising:
a barrel having a lower opening through which liquid is aspirated into the barrel and dispensed from the barrel, wherein the diameter of the lower opening is less than the diameter of the barrel at an upper end of the barrel;
a collar having a continuous inner surface with a circular circumference in its relaxed state, an upper opening for receiving the tip mounting shaft, and a lower end with an inside diameter that is larger than an inside diameter of the upper end of the barrel;
a circumferential tip shoulder connecting the lower end of the collar to the upper end of the barrel;
a circular cantilever sealing ring having an annular wall extending from the tip shoulder towards the collar opening for laterally engaging and sealing against the sealing area of the mounting shaft when the tip is fully mounted to the mounting shaft; and
said annular wall having a having a top edge that abuts the stop on the pipette mounting shaft when the tip is fully mounted to the mounting shaft;
wherein the collar of the disposable pipette tip is sufficiently flexible to distort outwardly at the lobes on the mounting shaft and inwardly at the recessed relief portions on the mounting shaft between the lobes when the pipette tip is mounted on the tip mounting shaft, and wherein the circumferential shoulder has sufficient structural integrity to maintain adequate roundness of the circular cantilever sealing ring so that the annular wall seals laterally against the sealing area of the mounting shaft.

2. A disposable pipette tip as recited in claim 1 further comprising means for engaging the respective locking lobes on the mounting shaft after the collar has been distorted outwardly at the lobes and inwardly at the recessed relief portions when the disposable pipette tip is mounted on the tip mounting shaft and the annular wall engages the stop on the mounting shaft.

3. A disposable pipette tip as recited in claim 2 wherein said means for engaging the pipette surfaces on the respective locking lobes comprising a locking ring extending inward from the continuous inner surface of the collar and around the entire circumference of the collar or substantially around the entire circumference of the collar and located at a rim of the upper opening of the collar and above the circumferential shoulder at a distance corresponding to the longitudinal distance between the stop on the mounting shaft and the peaks of the respective locking lobes on the mounting shaft.

4. The disposable pipette tip as recited in claim 1 wherein the circumferential shoulder reduces the internal bore diameter of the pipette tip by 0.1 to 1.0 mm.

5. The disposable pipette tip as recited in claim 1 wherein an inside surface of the annular wall slants inward in its relaxed state as it extends from the circumferential shoulder toward the opening in the collar.

6. The disposable pipette tip as recited in claim 5 wherein an inside surface of the annular wall forms an interference of 0.05 to 0.11 mm with a cylindrical sealing region on said mounting shaft.

7. The disposable pipette tip as recited in claim 5 wherein the slant of the inside surface continues as the surface extends downward to a threshold location for zero interference location and beyond the threshold location to provide ample clearance between the inside surface of the pipette tip and the mounting shaft below the threshold location.

8. The disposable pipette tip as recited in claim 7 further comprising a stabilizing ring located in an upper portion of the tip barrel which extends inward from the inside surface of the barrel.

9. The disposable pipette tip as recited in claim 1 further comprising a stabilizing ring located in an upper portion of the tip barrel.

10. The disposable pipette tip as recited in claim 1 wherein the circular cantilever sealing ring on the pipette tip further comprises a circumferential gap above the circumferential shoulder between the annular wall of the circular cantilever sealing ring and the tip collar.

11. The disposable pipette tip as recited in claim 8 wherein the height of the circumferential gap is in the range of 0.28 to 0.38 mm.

12. The disposable pipette tip as recited in claim 2 wherein said means for engaging the respective locking lobes on the mounting shaft comprises circumferential locking ring at or near the opening of the collar.

13. The disposable pipette tip as recited in claim 9 wherein the circumferential locking ring includes a void.

14. The disposable pipette tip as recited in claim 1 wherein the pipette tip is made of molded polypropylene.

15. A pipette system comprising:
disposable pipette tip having
barrel with a lower opening through which liquid is aspirated into the barrel and dispensed from the barrel,
a collar having an upper opening for receiving a pipette tip mounting shaft, wherein the lower end of the collar has a larger inside diameter than the inside diameter at the upper end of the barrel, and a circumferential shoulder that connects the lower end of the collar to the upper end of the barrel, and
a circular cantilever sealing ring having an annular wall extending from the tip shoulder towards the collar opening and having an inside surface, a top edge and a corner between the inside surface and the top edge, wherein said inside surface slants inward as it extends upward towards the collar opening; and
a pipette tip mounting shaft including
an upper locking section having a stop that engages and abuts annular wall of the circular cantilever sealing ring when the mounting shaft is fully inserted into the collar of the pipette tip,
a sealing section below the stop that laterally engages the inside surface of the annular wall of the circular cantilever sealing ring on the pipette tip to seal the mounting shaft against the pipette tip when the mounting shaft is fully inserted into the collar of the pipette tip;
multiple outwardly extending lobes circumferentially spaced around the upper locking section of the mounting shaft and located above the stop on the mounting shaft for engaging the inside surface of the collar, and recessed relief portions spanning between the lobes and recessed relative to the lobes such that the collar distorts outwardly at the lobes and inwardly at the relief portions when the pipette tip is mounted on the mounting shaft over the stop and the lobes.

16. The pipetting system recited in claim 15 wherein the sealing region of the mounting shaft is cylindrical.

17. The pipetting system recited in claim 15 wherein the sealing region of the mounting shaft includes an O-ring.

18. The pipetting system recited in claim 15 wherein the stop on the mounting shaft is angular and the angular stop engages said corner of the annular wall of the circular cantilever sealing ring when the mounting shaft is fully inserted in the pipette tip.

19. The pipetting system recited in claim 15 wherein each lobe includes a peak portion that is located at a maximum outward distance from a longitudinal axis of the mounting shaft, an inclining ramp portion that slopes outward as the inclining ramp extends upward along the mounting shaft towards the peak portion in order to facilitate distortion of the pipette tip collar as the mounting shaft is inserted into the pipette tip, and a declining ramp portion that slopes inward as the declining ramp extends upward along the mounting shaft away from the peak.

20. The pipetting system recited in claim 15 wherein the inside surface of the collar of the pipette tip includes a substantially circumferential locking ring extending inward from an inside surface of the collar, which engages the two or more outwardly extending lobes on the mounting shaft when the pipette tip is fully mounted on a pipette mounting shaft.

21. The pipetting system recited in claim 20 wherein the circumferential locking ring includes a void.

22. The pipetting system recited in claim 15 wherein the mounting shaft has lobes for engaging an inside surface of the collar of the pipette tip.

23. The pipetting system recited in claim 15 wherein the mounting shaft further comprises a leading tapered region below the sealing region, such that the outside diameter of the leading tapered region is less than the inside diameter of the inside surface of the annular wall of the circular cantilever sealing ring on the pipette tip.

24. The pipetting system recited in claim 15 wherein an inside surface of the annular wall slants inward in its relaxed state as it extends from the circumferential shoulder toward the opening in the tip collar.

25. The pipetting system recited in claim 16 wherein an inside surface of the annular wall forms an interference of 0.04 to 0.12 mm with the cylindrical sealing region on said mounting shaft.

26. The pipetting system recited in claim 16 wherein the slant of the inside surface continues as the surface extends downward to a threshold location for zero interference location and beyond the threshold location to provide ample clearance between the inside surface of the pipette tip and the mounting shaft below the threshold location.

27. The pipetting system recited in claim 15 wherein the disposable pipette tip comprises a stabilizing ring located in an upper portion of the tip barrel which extends inward from the inside surface of the barrel.

28. The pipetting system recited in claim 15 wherein the circular cantilever sealing ring on the pipette tip further comprises a circumferential gap above the circumferential shoulder between the annular wall of the circular cantilever sealing ring and the tip collar.

29. The pipetting system recited in claim 28 wherein the height of the circumferential gap is in the range of 0.28 to 0.38 mm.

30. The pipetting system as recited in claim 15 wherein the system includes multiple pipette mounting shafts, each in accordance with the limitations recited in claim 15 for the pipette mounting shaft.
